(19) United States
(12) Patent Application Publication
(10) Pub. No.: US 2006/0266201 A1
(43) Pub. Date: Nov. 30, 2006

(54) Method for synchronizing at least one multimedia peripheral of a portable communication device, and corresponding portable communication device

(76) Inventors: Minh Le, Neuilly Sur Seine (FR); Michael Guilbaud, Toulouse (FR); Muriel Gohn, Chatou (FR)

Correspondence Address: SOFER & HAROUN LLP., 317 MADISON AVENUE, SUITE 910, NEW YORK, NY, 10017, US

(21) Appl. No.: 11/429,406

(22) Filed: May 5, 2006

(30) Foreign Application Priority Data
May 12, 2004 (EP) 05 300 371.1

(51) Int. Cl. G10H 7/00

(52) U.S. Cl. 84/645

(57) ABSTRACT

A method for synchronizing at least one multimedia peripheral of a portable communication device with a synthetic audio file (1), which method comprises a step of generating at least one synchronization signal (Sⁱ_{SYNCH}) from said synthetic audio file (1). According to the invention, said method comprises an initialization step (A₀) consisting in memorizing, at said portable communication device, parameters (2) including at least a list of preferred instruments; and a generating step (A₁) comprising a step of analyzing (A₁₀) information read from said synthetic audio file (1) relating to each instrument for which a track can be extracted in said synthetic audio file (1), and a step of deciding (A₁₁) which extracted track is to be used for generating said synchronization signal (Sⁱ_{SYNCH}) as a function of said parameters. Said parameters (2) also include a predetermined frequency threshold, and said means for reading and analyzing are adapted to determine the frequency apparition of notes in said synthetic audio file for each extracted track.

### RELATED APPLICATION

This application is related to and claims the benefit of priority from European Patent Application No. 05 300 371.1, filed on May 12, 2005, the entirety of which is incorporated herein by reference.

### FIELD OF THE INVENTION

The present invention relates to a method for synchronizing at least one multimedia peripheral of a portable communication device, such as a mobile phone, with a synthetic audio file.

### BACKGROUND

The wording “multimedia peripherals” relates here to the different parts of the portable communication which can be activated in synchronization with music, for instance, in case of a mobile phone:
the ringer for alerting a user in case of reception of an incoming call or a message;
vibrator means which might be used either instead of or combined with the ringing;
the backlighting which is used for illuminating the display;
the backlighting used for illuminating one or several keys on the keypad;
Any dedicated illuminating devices such as leds which could be provided on the mobile phone.

Synthetic audio files relate to all kinds of files which contain numeric data enabling a synthesizer to generate a music or melody, such as the standardized files known as MIDI (Acronym for Musical Instrument Digital Interface), or SP-MIDI, or SMAF ( Acronym for Synthetic music Mobile Application Format). More precisely, MIDI files do not contain any sound. They are in fact text files, containing encoded commands which enable a synthesizer to play notes. Numbers specify each note's position relative to the start of the music and its time-value, and its volume, including Crescendos and Diminuendos. Other commands set the instrument (e.g. 1=Grand Piano, 74=Flute) for each track/channel, the Tempo changes and the overall volume and stereo balance per track.

Providing a portable communication device, such as a mobile phone, with means to synchronize one peripheral multimedia, as defined hereinabove by way of non-limitative examples, with a synthetic audio file is already known.

Generally, the synthetic files used for this particular application are specific as they contain a particular instrument which is to be used for synchronizing one peripheral multimedia, for instance instrument 125 in case of the ringing tone, or instrument 12 in case of the vibrator the ringer of the mobile phone. These specific synthetic files can be loaded in the memory of the mobile phone at the time of manufacturing. Alternatively, the user can download new synthetic files, either via the cellular network to which the mobile phone is affiliated, or via any type of networks including Internet, or from a PC. Once these files have been downloaded and stored in the memory of the mobile phone, the user has generally the possibility, via a specific menu, to choose the file which can be used for synchronizing each multimedia peripheral provided in its mobile phone.

The possibility for a user to give a personal touch to its portable communication device is consequently limited to what manufacturers or networks operators or services providers propose. However, the synthetic audio files which are proposed do not always correspond to the user's preferences.

A larger choice could be given to the user if he could use any type of synthetic audio files, even those which have not been created for the purpose of synchronizing a multimedia peripheral of a portable communication device. However in this case, if the file does not contain any information for the synchronization (for instance no track relating to either instrument 125 or to instrument 12), the user will not be able to use this file for synchronization purpose.

### OBJECTS AND SUMMARY OF THE INVENTION

The aim of the invention is to remedy the above drawback by proposing a solution enabling to systematically synchronize a multimedia peripheral with information coming from any type of synthetic audio file, whatever the content of this audio file, and especially even in case in which no synchronization information is contained in this audio file.

To this aim, an object of the present invention is to provide a method for synchronizing at least one multimedia peripheral of a portable communication device with a synthetic audio file, which method comprises a step of generating at least one synchronization signal from said synthetic audio file, characterized in that it further comprises the following steps:
An initialization step consisting in memorizing, at said portable communication device, parameters including at least a list of preferred instruments;
A generating step comprising a step of analyzing information read from said synthetic audio file relating to each instrument for which a track can be extracted in said synthetic audio file, and a step of deciding which extracted track is to be used for generating said synchronization signal as a function of said parameters;
   wherein said parameters also include a predetermined frequency threshold, said step of analyzing information further comprising determining the frequency apparition of notes in said synthetic audio file for each extracted track, and said deciding step consisting in choosing an extracted track corresponding to an instrument which belongs to said list of preferred instruments according to a comparison between the frequency apparition of notes and said predetermined frequency threshold.

For instance, an extracted track can be chosen if it corresponds to an instrument which belongs to said list of preferred instruments and if the frequency apparition of notes for this track is greater or equal to said predetermined frequency threshold.

According to one possible embodiment of the invention, said method may further comprise a step for determining if a synchronization track is present in said synthetic audio file.

In case a synchronization track is determined, said synchronization track may be automatically chosen for generating said synchronization signal. Alternatively, it can be decided to choose another track as a function of said parameters, even in case a synchronization track has been found. Alternatively, it can also be decided to elect the best track between either a synchronization track, or another extracted track chosen as a function of said parameters.

In any case, the method according to the invention enables a user to use any kind of synthetic audio file, whatever the presence or absence of a synchronization track in this file.

According to the invention, said deciding step preferably consists in choosing an extracted track corresponding to an instrument which belongs to said list of preferred instruments.

Said parameters may also include priority information for each preferred instrument. In this case, the extracted track will be preferably chosen according to said priority information.

A second object of the present invention is a portable communication device comprising at least one multimedia peripheral which can be activated with synchronism with at least one synchronization signal generated from a synthetic audio file, characterized in that it comprises:
Means for memorizing, at said portable communication device, parameters including at least a list of preferred instruments;
Means for reading and analyzing information read from said synthetic audio file relating to each instrument for which a track can be extracted in said synthetic audio file, and
Means for selecting which extracted track is to be used for generating said synchronization signal as a function of said parameters and for creating said synchronization signal;
   and in that, said parameters also include a predetermined frequency threshold, said means for reading and analyzing being adapted to determine the frequency apparition of notes in said synthetic audio file for each extracted track, and means for selecting causing the selection of an extracted track corresponding to an instrument which belongs to said list of preferred instruments according to a comparison between the frequency apparition of notes and said predetermined frequency threshold.

### BRIEF DESCRIPTION OF THE DRAWINGS

Other features and advantages of the invention will become apparent from the following description of embodiments of the invention given by way of non-limiting examples only and with reference to the accompanying drawings, in which:

FIG. 1 shows schematically the different steps involved in the method according to a first possible embodiment of the present invention;

FIG. 2 shows an example of synchronization extraction according to the present invention, for a particular example of MIDI file;

FIG. 3 illustrates schematically possible means to implement the method according to the present invention.

### DETAILED DESCRIPTION

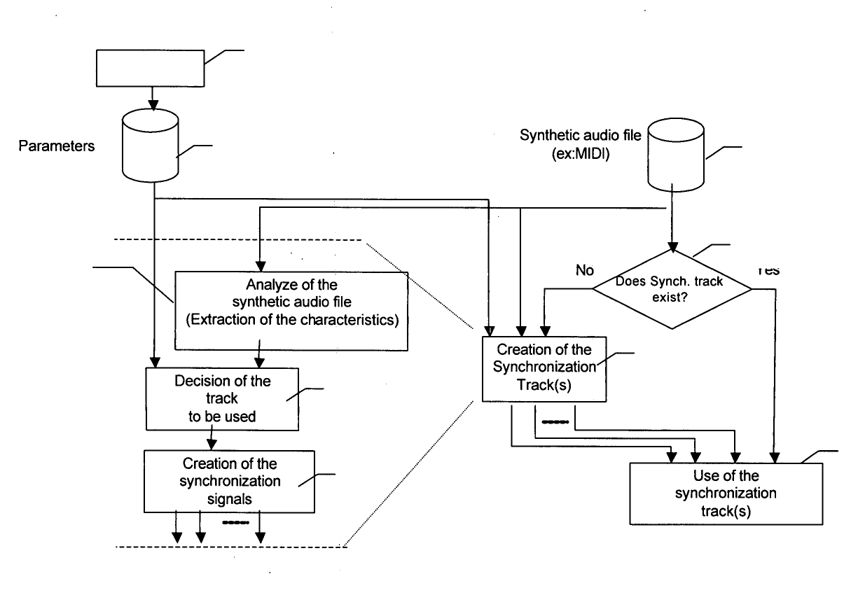

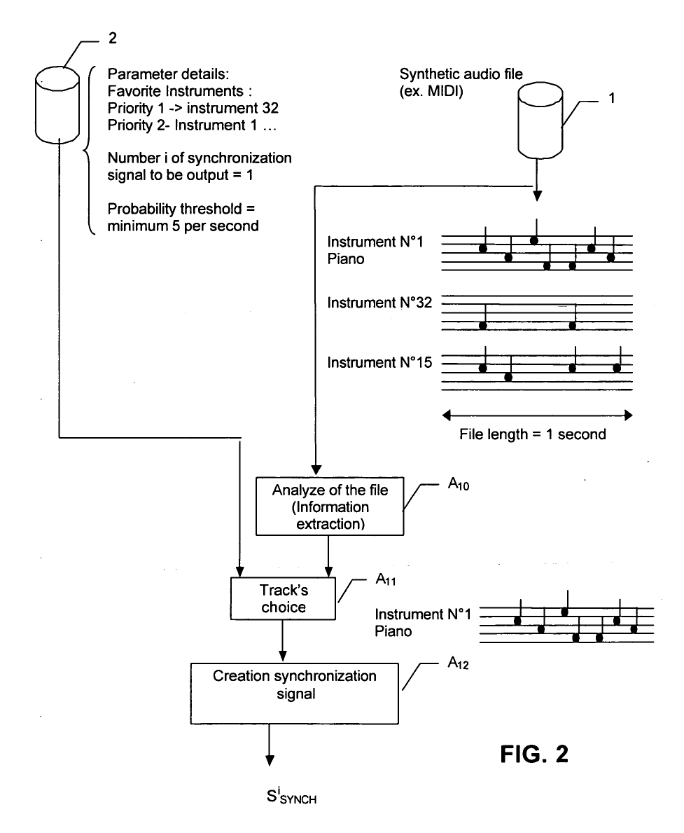

In relation with FIGS. 1 and 2, the method for synchronizing at least one multimedia peripheral of a portable communication device according to the invention consists in generating at least one synchronization signal Sⁱ_{SYNCH} from a given synthetic audio file 1.

According to a first aspect of the invention, the method comprises an initialization step A₀ during which some parameters 2, including at least a list of preferred instruments, are memorized at the level of said portable communication device.

Said initialization step A₀ may be performed at the manufacturing of the portable communication device. Alternatively or in combination, a suitable menu can be configured by the user himself.

In the example shown on FIG. 2, the list of preferred instruments comprises two favorite instruments, namely instrument N°32 (corresponding to Guitar harmonic for the MIDI standard), and instrument N° 1 (corresponding to Grand Piano for the MIDI standard).

According to a second aspect of the invention, a generating step A₁ is performed, comprising a step A₁₀ of analyzing information read from synthetic audio file 1 and relating to each instrument for which a track can be extracted in said synthetic audio file, and a step A₁₁ of deciding which extracted track is to be used for generating said synchronization signal as a function of said parameters.

For illustrative purpose, let's assume that synthetic audio file 1 contains several tracks corresponding to several instruments, among which we can find, as illustrated on FIG. 2, at least the following tracks:

a track relating to Instrument N°1 (Piano) with the corresponding notes to be played for this instrument;

a track relating to Instrument N°32 (Guitar harmonic) with the corresponding notes to be played for this instrument;

a track relating to Instrument N°15 (tubular bells) with the corresponding notes to be played for this instrument.

In the example of FIG. 2, the score corresponding to each of the instruments has been given for duration of one second. Of course, longer duration are possible.

During generating step A₁, and more precisely during step A₁₀, at least those three tracks will be extracted.

Deciding step A₁₁ will then consist in choosing an extracted track corresponding to an instrument which belongs to said list of preferred instruments. Extracted track corresponding to instrument N°15 will not be considered furthermore since it does not belong to the list of preferred instruments.

In this preferred embodiment, parameters 2 also include priority information for each preferred instrument. In this case, the extracted track will be preferably chosen according to said priority information. For the given example, priority information has been set to priority 1 for instrument N° 32 and to priority 2 for instrument N°1, which means that, as both tracks corresponding to both instruments can be found in synthetic audio file 1, preference will be given to instrument N°32.

Other parameters can be added: In the preferred embodiment, parameters 2 also include a predetermined probability or frequency threshold. In this specific case, step A₁₀ of analyzing information further comprises determining the frequency apparition of notes in synthetic audio file 1 for each extracted track, and deciding step A₁₁ consists in choosing an extracted track not only corresponding to an instrument which belongs to said list of preferred instruments, but also according to a comparison between the frequency apparition of notes and said predetermined frequency threshold. The comparison may consist in selecting a track only among the extracted tracks for which the frequency apparition of notes is greater or equal to said predetermined frequency threshold.

In the example of FIG. 2, the frequency threshold is set to a minimum of 5 notes per second. Analyze of file 1 performed at step A₁₀ shows that seven notes exist for instrument N° 1, while only two notes exist for instrument N°32. In this case, decision on the track performed at step A₁₁ may consist in choosing track N° 1, despite the fact that priority 1 was set for instrument N°32, because the frequency apparition of notes for instrument N° 32 is below the frequency threshold.

Parameters 2 may also include the number I of synchronization signals which must be output. In the example of FIG. 1, this number has been set to 1. Parameters 2 could also comprise criteria relating to duration of notes, like a duration threshold. In this case, analysis of the duration of notes is performed for each instrument of the audio file, and only instrument for which the greater number of notes which duration is superior to the duration threshold has been found is selected. Another parameter could be a transition threshold between two successive notes for the same track . . .

At last, synchronization signal Sⁱ_{SYNCH} is created at step A₁₂, from the selected track. This signal can correspond to a succession of pulses corresponding to each note of the selected track, or may be adapted according to the type of peripheral which must be activated.

According to one possible embodiment of the invention, said method may further comprise a step A₃ for determining if a synchronization track is present in said synthetic audio file.

In case a synchronization track is determined, said synchronization track may be automatically chosen for generating said synchronization signal. Alternatively, it can be decided to choose another track as a function of parameters 2, even in case a synchronization track has been founded. Alternatively, it can also be decided to elect the best track between either a synchronization track, or another extracted track chosen as a function of parameters 2. This last case corresponds to what is shown on FIG. 1, wherein step A₄ enables to select the best track.

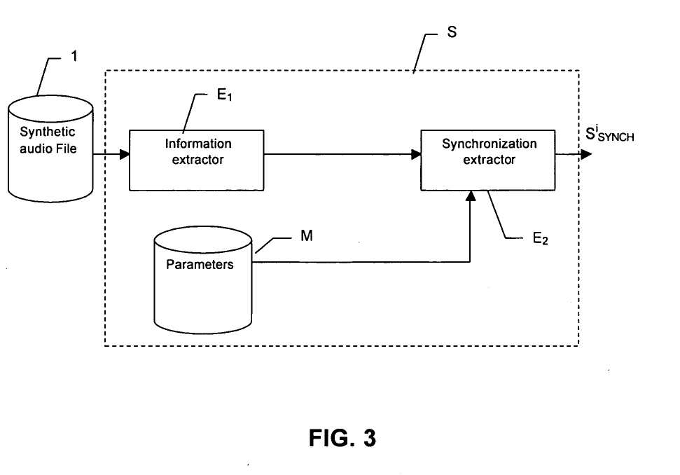

FIG. 3 shows schematically part of a portable communication device comprising at least one multimedia peripheral (not shown) which can be activated with synchronism with at least one synchronization signal Sⁱ_{SYNCH} generated from a synthetic audio file 1 stored in a memory of the device, implementing the method according to the invention. The portable communication device comprises synchronization generation means S including:
Means M for memorizing, at said portable communication device, parameters 2 including at least a list of preferred instruments, and eventually other parameters such as priority information, frequency threshold, and/or number of signals to be generated;
First extractor means E₁ for reading and analyzing information read from synthetic audio file relating to each instrument for which a track can be extracted in said synthetic audio file 1, and
Second extractor means E₂ for first, selecting which extracted track is to be used for generating said synchronization signal Sⁱ_{SYNCH} as a function of said parameters and then, for creating said synchronization signal Sⁱ_{SYNCH}.

The above synchronization generation means are controlled by the portable device's software.

Peripherals which can be activated in synchronism with synchronization signal Sⁱ_{SYNCH} can be a ringer and/or vibrator and or display backlight and or key backlight, and or any dedicated led on the portable communication device.

1. Method for synchronizing at least one multimedia peripheral of a portable communication device with a synthetic audio file, said method comprising the steps of:
generating at least one synchronization signal from said synthetic audio file;
An initialization step including memorizing, at said portable communication device, parameters including at least a list of preferred instruments;
A generating step for analyzing information read from said synthetic audio file relating to each instrument for which a track can be extracted in said synthetic audio file; and
a step of deciding which extracted track is to be used for generating said synchronization signal as a function of said parameters, wherein said parameters also include a predetermined frequency threshold, said step of analyzing information further determining the frequency apparition of notes in said synthetic audio file for each extracted track, and said deciding step including choosing an extracted track corresponding to an instrument which belongs to said list of preferred instruments according to a comparison between the frequency apparition of notes and said predetermined frequency threshold.

2. Method according to claim 1, further comprising a step for determining if a synchronization track is present in said synthetic audio file.

3. Method according to claim 2, wherein in case a synchronization track is determined, said synchronization track is automatically chosen for generating said synchronization signal.

4. Method according to claim 1, wherein said deciding step includes choosing an extracted track corresponding to an instrument which belongs to said list of preferred instruments.

5. Method according to claim 4, wherein said parameters also include priority information for each preferred instrument, and in that the extracted track is chosen according to said priority information.

6. Method according to anyone of the preceding claims, characterized in that said deciding step (A₁₁) consisting in choosing an extracted track corresponding to an instrument which belongs to said list of preferred instruments and for which the frequency apparition of notes is greater or equal to said predetermined frequency threshold.

7. Portable communication device comprising;
at least one multimedia peripheral which can be activated with synchronism with at least one synchronization signal generated from a synthetic audio file, said multimedia peripheral further maintaining;
Means for memorizing, at said portable communication device, parameters including at least a list of preferred instruments;
Means for reading and analyzing information read from said synthetic audio file relating to each instrument for which a track can be extracted in said synthetic audio file; and
Means for selecting which extracted track is to be used for generating said synchronization signal as a function of said parameters and for creating said synchronization signal, wherein said parameters also include a predetermined frequency threshold, said means for reading and analyzing being adapted to determine the frequency apparition of notes in said synthetic audio file for each extracted track, and means for selecting causing the selection of an extracted track corresponding to an instrument which belongs to said list of preferred instruments according to a comparison between the frequency apparition of notes and said predetermined frequency threshold.

8. Portable communication device according to claim, wherein said multimedia peripheral is a ringer and/or a vibrator and or display backlight and or key backlight, and/or any dedicated led on the portable communication device.
